(19) United States
(12) Patent Application Publication
(10) Pub. No.: US 2006/0178908 A1
(43) Pub. Date: Aug. 10, 2006

(54) Method, apparatus and system for providing targeted information in relation to laboratory and other medical services

(76) Inventor: Alain T. Rappaport, San Mateo, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/334,197

(22) Filed: Jan. 18, 2006

Related U.S. Application Data
(63) Continuation of application No. 09/754,547, filed on Jan. 3, 2001, now abandoned.
(60) Provisional application No. 60/174,369, filed on Jan. 4, 2000.

(51) Int. Cl. G06Q 10/00; G06F 17/30

(52) U.S. Cl. 705/2; 707/3

(57) ABSTRACT

According to one aspect of the present invention, a method is provided in which information about a medical procedure/test is received. The information about the medical procedure/test may include one or more codes or descriptions relevant to the patient and procedure/test that are used to process, identify or classify the medical procedure/test performed by a service provider. Upon receiving the information about the medical procedure/test, a query function is performed to retrieve from a database a list of data sources and/or support information that correspond to the information received. One or more documents are generated that contain the list of data sources and/or support information retrieved from the database.

### CROSS-REFERENCE TO RELATED APPLICATIONS

This application is a continuation of U.S. application Ser. No. 09/754,547, filed Jan. 3, 2001, which claims priority from U.S. Provisional Application No. 60/174,369, filed Jan. 4, 2000, both of which are incorporated by reference herein.

### BACKGROUND OF THE INVENTION

1. Field of the Invention

The present invention relates generally to the field of information processing. More specifically, the present invention relates to a method, apparatus, system, and machine-readable medium for providing targeted information in relation to laboratory and other biomedical or clinical services.

2. Description of the Related Art

There are several hundreds of millions of tests and other procedures performed every year as services to assist healthcare providers in providing care. The main output of testing laboratories and other medical services is to provide data or results to providers. There has been a well-identified trend to provide information in addition to data to the providers or care givers. This has resulted mainly in the inclusion of normal or reference ranges information to guide the healthcare providers in the data interpretation.

A key information that healthcare providers need is evidence from the medical literature, outcome studies and other studies to help them manage clinical situations. However, the pressures of fixed-budget healthcare are among the factors that make it difficult for physicians and other providers to keep track of the fast evolving clinical and basic sciences relevant to their practices as well as other developments in, for example, public health or other fields. On-going research, outcome studies and other important information relevant to the interpretation and use of test results are not readily available. Finding them is time-intensive, and requires a dedicated effort, particularly when using the Internet (or the web) where information is rapidly posted in numerous, large and complex databases (e.g., PubMed or MedLinePlus from the National Institutes of Health). Support and evidence-based information is not only necessary for existing tests and procedures, but it will be increasingly essential for new generation tests and screening, including, but not limited to, genetic and molecular profiles and screenings, and others. In addition, even if some of the healthcare providers had the time and resources to search the various databases for information concerning the test data/results, it is very likely that they would be overwhelmed with irrelevant and untargeted information or information from unreliable sources, etc.

Accordingly, there exists a need for the health care providers to efficiently and effectively locate and obtain relevant, useful, and targeted information concerning the results and data of laboratory tests, procedures, and other medical services.

### SUMMARY OF THE INVENTION

According to one aspect of the present invention, a method is provided in which information about a medical procedure/test is received. The information about the medical procedure/test may include one or more codes or descriptions relevant to the patient and procedure/test that are used to process, identify or classify the medical procedure/test performed by a service provider. Upon receiving the information about the medical procedure/test, a query function is performed to retrieve from a database a list of data sources and/or support information that correspond to the information received. One or more documents are generated that contain the list of data sources and/or support information retrieved from the database.

### BRIEF DESCRIPTION OF THE DRAWINGS

The features and advantages of the present invention will be more fully understood by reference to the accompanying drawings, in which:

FIG. 1 illustrates a block diagram of one embodiment of a system according to the teachings of the present invention;

FIG. 2 shows a detailed block diagram of one embodiment of the system in FIG. 1;

FIG. 3 is a functional block diagram of one embodiment of a system according to the teachings of the present invention;

FIG. 4 illustrates a structure diagram of one embodiment of a database according to the teachings of the present invention;

FIG. 5 shows a tree-view diagram of one embodiment of the database illustrated in FIG. 4;

FIG. 6 is a structure diagram of one embodiment of a database according to the teachings of the present invention;

FIG. 7 shows a tree-view diagram of one embodiment of the database shown in FIG. 6;

FIG. 8 illustrates a flow diagram of one embodiment of a method in accordance with the teachings of the present invention;

FIGS. 9A and 9B show a block diagram one embodiment of a method according to the teachings of the present invention;

FIG. 10 is a flow diagram of one embodiment of a method according to the teachings of the present invention;

FIG. 11 illustrates a block diagram of one embodiment of a method according to the teachings of the present invention; and

FIGS. 12A, 12B, and 12C illustrate an example of one embodiment of a web user interface for presenting personalized health-related information and links to other sources of relevant information, in accordance with the teachings of the present invention.

### DETAILED DESCRIPTION OF THE PREFERRED EMBODIMENT

In the following detailed description numerous specific details are set forth in order to provide a thorough understanding of the present invention. However, it will be appreciated by one skilled in the art that the present invention may be understood and practiced without these specific details.

In the discussion below, the teachings of the present invention are utilized to implement a method, apparatus, system, and machine-readable medium to provide relevant, useful, and targeted support information concerning a medical procedure/test performed for a patient by a service provider (e.g., laboratory, physician's office, etc.) In one embodiment, information about a particular medical procedure/test performed for a patient based upon a request by the patient's healthcare provider (e.g., physician) is received from one or more sources including the service provider, the patient's healthcare provider or physician, etc. The information about the medical procedure/test received from the various sources may include one or more codes and/or description corresponding to the medical procedure/test performed, results and data generated from the medical procedure/test performed, diagnosis information, patient information such as name, date of birth, gender, etc. When the information about the medical procedure/test performed for the patient is available, a query function is performed to retrieve from a database (also referred to as the Evidence Database or EDB herein) a list of data sources (also called list of content links) and support information corresponding to the information received. In one embodiment, the information and data contained in the Evidence database may include supporting evidence information from the medical literature and other sources that are relevant and targeted to the patient and the procedure/test in question. In one embodiment, evidence-based support information can be represented by links to external sources of information which may include, but is not limited to, systematic reviews, meta-analyses results, Randomized Controlled Trials (RCTs) information and results, etc. In addition to evidence-based support information, other types of support information, for example laboratory support information, interpretive information may also be included. In one embodiment, such laboratory support information, can be links derived from the content database of the laboratory or service provider that are indexed in the Evidence database. In one embodiment, laboratory support information may include the following:—explanations of the testing or screening techniques and information on the test's performance characteristics;—information on whether a test should be used for clinical diagnosis or treatment definition;—targeted reflex algorithm to integrate results in clinical decision-making, etc. The one or more procedure/test codes, in one embodiment, are codes that are used according to the Current Procedure Terminology (CPT). The one or more diagnosis codes, in one embodiment, are codes that are used according to the International Classification of Disease (ICD). The diagnosis information received may include one or more descriptions describing the patient's conditions and/or problems based upon the diagnosis performed by the healthcare provider. In one embodiment, the information about the patient may also include the patient's personal and profile information, prescription information, materials and supplies information, and injection information, etc. that may or may not have corresponding codes.

In one embodiment, upon receiving the information about the medical procedure/test and information about the patient, a set of queries is generated containing query criteria based upon the information received. The set of queries is executed to retrieve from the database the list of data sources and other support information corresponding to the query criteria. In one embodiment, a data source is referenced by an address corresponding to a location where the respective data sources resides. The address corresponding to the location where the data source resides may be referenced by a Uniform Resource Locator (URL). In one embodiment, the one or more documents or interactive services generated may be accessible by the healthcare provider and other entities via a computer network, for example via the Internet. In one embodiment, the healthcare provider is allowed to provide feedback or comments with respect to the information contained in the one or more documents.

In one embodiment, the database is structured to include a list of codes where each code is used to identify or indicate a particular medical procedure/test. For each code in the list, the database may also contain a list of one or more definitions of the respective code. In one embodiment, the database is used to store a list of data sources identified using the one or more definitions associated with each code. In one embodiment, the database is also configured to store a set of queries associated with each code. The set of queries associated with each code is constructed based upon the one or more definitions corresponding to the respective code. In one embodiment, the list of data sources associated with a particular code is obtained by running the corresponding set of queries against various databases available on the World Wide Web (WWW) to identify one or more documents or content links or services that match the query criteria specified in the corresponding queries. In one embodiment, a selection process is performed to select the list of data sources for the respective code from the documents or content links identified from the various web databases.

The teachings of the present invention are applicable to any search engines and directory systems that are used to provide health-related information to users. The teachings of the present invention are also applicable to any method, system, or mechanism for providing health-related information to the users based upon query criteria submitted by the users or other sources. However, the present invention is not limited to providing health-related information to the users and can be applied to other types of information processing in other business areas or disciplines.

According to one aspect of the present invention, the system and method described herein are designed to provide information services to healthcare providers and other entities by providing the healthcare providers and other entities with relevant, useful, and targeted evidence-based support information and other types of support information (e.g., laboratory support information) that are tailored based upon the particular procedures/tests performed for patients. The relevant, useful, and targeted support information concerning a particular procedure/test performed for a specific patient is generated by the system and included in a document referred to as a “Labstory”. Each Labstory may have a unique identifier. In one embodiment, each Labstory is designed to contain basic patient and provider information, diagnosis information which may include diagnosis code(s) and remarks, procedure/test information including codes or identifiers for the particular procedure/test ordered, test data and results, evidence-based support information and other types of support information including laboratory support information, etc. that are relevant and targeted to the particular procedure/test performed.

Access to a Labstory “document” by a healthcare provider or another entity can be achieved in various ways. In the following description, the Internet/World-Wide-Web model is used for explanation and illustration purposes. Accordingly, a Labstory can be a “web document” or “web site” accessible by the healthcare provider or other entities via the Internet. However, other communications means may be used, such as television, cable, information appliances, telephone, wireless devices, handheld devices and other technologies. The Evidence Database is independent of the media or user interface. In the television example, the information service delivered to the healthcare providers or other entities may be a series of videos or programs directly relevant to the particular procedure/test in question.

Communications between the different entities (e.g., healthcare providers, service and laboratory providers, health plan and health care organization, provider organization and Labstory system, other organizations or companies that may provide information) can take place in any manner (including but not limited to telephone, fax, Internet, email, world-wide-web, wireless networks, etc.). Service providers, for example, could provide code and other information to Labstory system using worldwide web clients, wireless clients, telephone, and others.

Communications and interoperability between the different software and hardware components can make use of different systems including, but not limited to, CORBA, DCOM, COM, RMI or other RPC. Protocols can also vary, including, but not limited to, HTTP, SMTP, NNTP or “push” protocols. Different solutions can be implemented concerning the security, privacy and confidentiality of information, including for example, secure http (“https”) for security.

Contents may be implemented in any language (or mix of languages) including, but not limited to HTML (HyperText Markup Language), XML (Extensible Markup Language), SGML (Standard Generalized Markup Language), Java, C, C++, and others. Programmatic interfaces for modifying content can be implemented following different specifications, including DOM (Document Object Model) as an example. Other delivery technologies such as television or handheld devices may require other languages or formats (e.g. Wireless Markup Language, WML, for handheld devices). Final rendering could also be provided speech generation systems or other interfaces.

According to the teachings of the present invention, the system and method described herein are designed to provide relevant, useful, and targeted information services to eliminate the complexity of obtaining and using on-line health information and to provide rapid, highly targeted, direct-to-customer (DTC) services, following each procedure/test performed for a patient.

In one embodiment, upon receiving information about a particular procedure/test performed for a patient, the system and method described herein are designed to generate a web document, called Labstory, which includes basic patient and healthcare provider information, diagnosis information, test data and results, evidence-based support information and other types of support information that are relevant and targeted to the particular procedure/test, the patient, and the healthcare provider that are involved in the process.

In one embodiment, the information services and methods provided by the Labstory system are aimed at creating highly targeted, content-rich and evidence-based reports for healthcare providers that request medical services including, but not limited to, diagnostic tests, molecular profile tests, imaging procedures and others. Examples of laboratory test categories include chemistry, coagulation, hematology, immunology, genetics and genomics, proteomics, perinatal, emergency, histology or cytogenetic tests. For example, the Labstory information services and methods can be applied to procedures and tests in allergy, cardiology, endocrinology, forensic medicine, gastroenterology, genetic medicine, gynecology, geriatrics, infectious diseases, nephrology, obstetrics, oncology, orthopedics, respiratory diseases, reproductive medicine, rheumatology, surgical services, urology and others.

The information services and methods described herein are applicable to any procedure or test following one or several specific requests or requisitions for specific services. As described above, the Labstory document that is generated according to the teachings of the present invention contains not only the results and data of the particular procedures or test in question, but also relevant and targeted supporting information that helps the user of the test data/results (e.g., physician or other provider) in their process of evaluating, understanding, communicating or managing the test or procedure information including the results.

The supporting information itself and the “links” and “references” to it are determined based on a combination of basic medical, biomedical, clinical, diagnostic, procedural or other information. Other types of information may be added as well to the document such as, but not limited to, relevant information from the patient's health plan, medical group or other players in the healthcare delivery chain. Thus, several types of services may be bundled in any given Labstory.

The teachings of present invention are utilized to provide, among other things, focused, targeted, provider and patient-specific information to support healthcare providers and other entities in their practice. The present invention is also designed to solve the problem of information quality by filtering irrelevant, insufficient or ancillary information.

In addition to providing targeted information with respect to particular procedures/tests in question and with respect to the patient's condition and medications based upon information obtained from existing medical databases, web sites or other information repositories, the Labstory system also aggregates and provides other services, which are also targeted to the procedure/test and conditions of the patient in question or more general in nature. They can include, but are not limited to, additional information from the laboratory or testing institution, health, diagnostic and therapeutic management information or programs, managed care organization benefits-related and intervention program services, health and risk assessment, suggestions for other tests or procedures, or indications that other tests, in the accumulated experience, may not be necessary, links to on-line drugstores, e-commerce, laboratory test history and other services. The Labstory information services can also include physician-specific information the specificity of which may be derived from the individual usage of medical services. Thus, the Labstory can be both patient-and provider-specific.

The teachings of the present invention can be utilized in various ways and manners to improve the effectiveness, efficiency, and quality of healthcare services in various areas of the healthcare industry as follows:

Targeted vehicle for physician relation management, support services and other functions on the part of the laboratories or other service providers.

Branding, co-branding, customization and services (Laboratory test companies, HMOs, PPOs, Insurers, IPAs, Medical Groups, . . . )

Bundled services (e.g. therapeutic management, laboratory results interpretation, information mediating services, health risk assessment) from Labstory or others.

Laboratory to Provider and Provider to Laboratory communications

E-commerce, including for example, but not limited to, the ordering of additional tests

Strategic deals with medical, health care and other content and service providers.

This could include medical journals, institutions, scientific companies or laboratories and others.

By providing personal, focused and pro-active information services to their customers through the Labstories, health care and providers organizations increase physician empowerment, customer loyalty, and decrease healthcare costs while increasing the quality of care, prevention and laboratory/provider and patient/provider interactions.

The Labstory method and system described herein is a highly cost-effective solution to provide healthcare providers and other entities with relevant, useful, and targeted support information, information with respect to various types of intervention programs, and to help laboratory and other services companies and institutions move from a result-oriented business into an information-oriented line of service that greatly enhances their value proposition and contribution to healthcare quality and cost efficiency. The present invention is designed to support actively the notion of “evidence-based medicine”.

Labstory's information services can be considered “real-time” in terms of health care delivery. Each procedure/test ordered is to be followed by the construction of a personalized and targeted on-line Labstory that is available as soon as possible. Furthermore, based on the reception of other low-resolution medical information, Labstory can provide longitudinal (historical) health information services (e.g. growth curves for children; vaccination schedules; pregnancy-related information in normal or high-risk pregnancies; condition management tips; etc.), as well as the past “collection” of Labstories.

By using various methods and mechanisms described herein according to the teachings of the present invention, the healthcare providers and other entities in the healthcare and healthcare delivery chain will be able to obtain relevant, useful, and targeted support information concerning the procedures/tests and the conditions of their patients.

One of the additional benefits and features provided by the Labstory is that it creates a light form of patient record by keeping a history (also referred to as a collection) of Labstories. Although the latter may not use the high-resolution information of a classic medical record, they do contain very useful historical information.

Various sources may provide the Labstory system with the necessary information (e.g., procedure/test data and results, diagnosis information, other low resolution medical data or “LRMD”, benefits, other services, etc.) for the generation of a Labstory following a procedure/test, including:

Service providers such as procedure/test/laboratory service providers: these entities can provide information such as procedure/test related information such as procedure/test codes, test data and results, basic information about the patient and the healthcare provider, diagnosis information if available, etc.

Healthcare providers (e.g., physicians, dentists, etc.): can provide to the system diagnosis or problem information, code as well as patient identification.

IPAs or other Provider Organizations: can provide related services and information, sent to Labstory system for inclusion in the Labstories or accessed through their own site directly referenced in the Labstory.

Health Care Organizations (HCOs) or Health Plans: can provide personal benefits and reimbursement information and targeted intervention programs that can be included in the Labstory document or can be accessed through their own site referenced in the Labstory.

In conjunction with a richer patient profile the personalization and targeting of the Labstory can be increased.

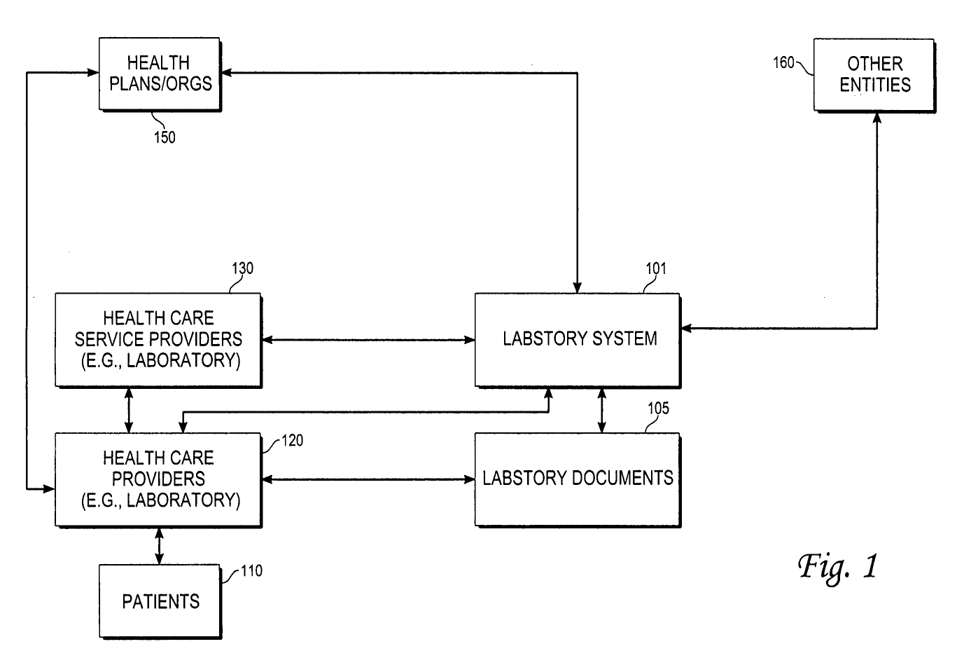

FIG. 1 illustrates a block diagram of one embodiment of a system environment and configuration 100 for providing targeted and personalized health-related information to patients following their interactions with their healthcare providers. In the present embodiment, various entities can be connected to a system 101 via a computer network. In one embodiment, the computer network can be a local area network (LAN), a wide area network (WAN), the Internet, or any combinations thereof. In one embodiment, the system 101 is an Internet-based system designed to perform various functions described in more details below. The various functions performed by system 101 include receiving information about the patient from various sources connected to the system 101 including the healthcare providers 120, the health care provider organizations 130, and the health plan organizations 140, and the patients 110, etc.; retrieving a list of data sources or content links from a database (also referred to as the Evidence database herein) corresponding to a set of queries generated based on the information about the patient received from the various sources; and generating one or more documents that contain the list of data sources retrieved from the Evidence database, etc. that can be accessed by the patient via the computer network. The various functions performed by the system 101 also include building and maintaining the Evidence database. The various functions performed by the system 101 are described in more details below.

Referring to FIG. 1, in one embodiment, the healthcare providers 120 can establish connections with the system 101 via the Internet. The healthcare providers 120 can access various documents (Labstories) that contain targeted evidence-based support information and other types of support information including laboratory support information that are generated by the system 101 following the completion of particular procedures/tests that are requested or ordered by the healthcare providers 120 for their patients 110. The healthcare providers 120 can also provide to the system 101 patient and provider information and other types of information that can be used by the system 101 in generating the Labstory documents and maintaining the patient's medical/health history with respect to certain procedures/tests that have been performed for the patients. Such information may include the patient personal information, low resolution medical information (e.g., weight, height, blood pressure, etc.), prescription information for prescription drugs and over-the-counter drugs, materials, supplies, or other physician-provided information or recommendations (e.g., counseling, education, diet, exercises, or other therapeutic services), and other comments. The healthcare providers 120 can also provide other types of information about the patient including vaccinations, pre-conditions, risks, etc. if applicable.

Continuing with the present discussion, in one embodiment, the healthcare service providers (e.g., laboratories) 130 can establish connection with the system 101 via an Internet connection. The healthcare service providers 130 can transmit to the system 101 various types of information about the procedures/tests performed for the patients 130 according to the request or order of the healthcare providers 120. Such information may include procedure/test information including procedure/test code(s) that are used to identify or indicate the particular procedures/tests performed and the test data and results. The healthcare service providers 130 can also transmit to the system 101 other types of information including diagnosis information (e.g., diagnosis codes and remarks, etc.) provided from the healthcare providers 120 and other basic information about the patient 110 and the healthcare providers. The healthcare provider organizations 140 to which the healthcare providers 120 belongs may also have other relevant information including local health data and news, community health news, information relating to their own campaigns or programs concerning prevention, intervention, quality of care, cost reduction, etc.

Similarly, the health plan organizations 150 can establish connection with the system 101 via an Internet connection. The health plan organizations 150 can provide to the system 101 various types of information about the patient including the information available on the patient's record including but not limited to explanations of benefits, referral services, etc. The health plan organizations 150 can also provide information regarding the current conditions and other associated benefits as they are available. Other entities or players 160 can also be connected to the system 101 including pharmaceutical companies, public health organizations, on-line drug stores, advertisers, etc. These various entities can also provide various types of information to the system 101 including targeted messages, general health-related information, specific health-related information, information concerning health-related issues and news, etc. The system 101, upon receiving the information about the procedures/test and information about the patient from various entities connected to the system 101, performs various functions as described in more details below to generate one or more documents that contain relevant and targeted evidence-based support information and other types of support information in addition to the test data and results that can be accessed by the healthcare providers 120 via the computer network. In another embodiment, the patients 110 and service providers 130 may also be allowed to have access to these Labstory documents.

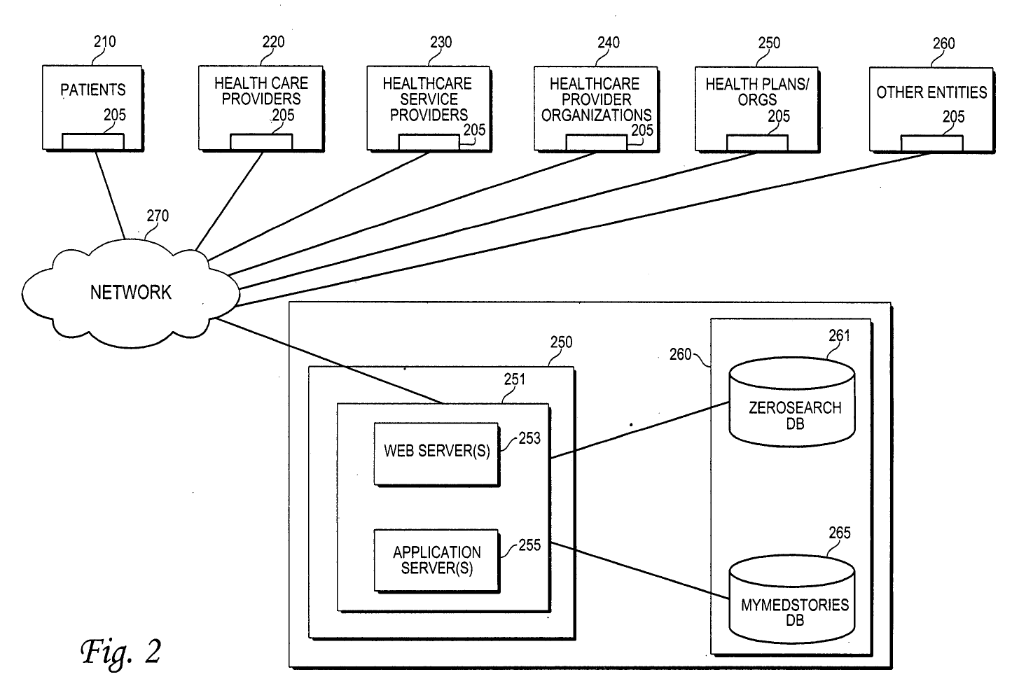

FIG. 2 illustrates a more detailed block diagram of one embodiment of the system configuration 100 shown in FIG. 1. For clarity and simplicity, the discussion herein is focused on the interactions between the healthcare providers 220, the healthcare service providers (e.g., laboratories) 230 and the system 201. However, everything discussed herein equally applies to other entities connected to the system 201 as well as in other environments. In one embodiment, the system 201 performs various functions based upon the information provided by the healthcare providers 220, the healthcare service providers 230, the healthcare provider organizations 240, and the health plan organizations 250, etc. The various functions performed by the system 201 include generating the Labstory documents based upon the information received from the healthcare service providers 230 and other sources, maintaining the Evidence database 261 that contains evidence-based support information and other types of support information including laboratory support information, etc.

In one embodiment, the system 201 can be logically organized into two major subsystems or units: a server subsystem or unit 250 and a database subsystem or unit 260. The server subsystem 250, in one embodiment, contains one or more servers 251. The database subsystem or unit 260, in one embodiment, contains a database 261 (the Evidence database) and a database 265 (the Labstories database). These various system components of the system 201 are described in greater detail below. Continuing with the present discussion, in one embodiment, the various entities can establish connection with the system 201 via the Internet and communicate with the system 201 using an Internet browser (also referred to as the client program). The various entities can establish connection with the system 201 using a router, a dial-up modem, or other methods of Internet connections available to them. The various entities can utilize an Internet browser to interface with the system 201 in order to provide information to the system 201 and access the various functions and features of the system 201. In one embodiment, the various entities connected to the system 201 can also use the browser client program to communicate with each other. In one embodiment, the system 201 can support both Microsoft® INTERNET EXPLORERS® and Netscape® NAVIGATOR® browser software.

In particular, the healthcare service providers 230 can use their browser client program to provide information about the procedures/tests to the system 201. The healthcare providers 220 can use their browser client program to provide information about the patient and the diagnosis, etc. to the system 201. The healthcare providers 220 can use their browser client program to access the various Labstory documents generated by the system 201 following the completion of the procedures/tests requested or ordered by the healthcare providers 220. Other entities including advertisers 290, in one embodiment, can establish connection with the system 201 via the Internet using routers, dial-up modems or other methods of Internet connections available to them. In one embodiment, the advertisers 290 use an Internet browser to access the system 201 to place their advertisements into the system 201 that can be displayed to the various users of the system 201. For example, an advertisement submitted by one of the advertisers 290 can be selected by system 201 to display to the healthcare providers 210 when they access the Labstory documents.

Referring again to FIG. 2, in one embodiment, the server(s) 251 is connected to the clients 205 via the network 270. In one embodiment, the server 251 includes a web server 253 and an application server 255. The web server 251 is used to communicate with the client 205 (e.g., a web browser front end). In another embodiment, the web server 251 and the application server 255 can be merged. The application server 253, in one embodiment, includes one or more computer programs that are designed to perform various functions described herein. In one embodiment, the application server 253, in performing its various corresponding functions, accesses and stores data in various databases in the database subsystem 260, including the Evidence database 261 and the Labstories database 265.

The Evidence database 261, in one embodiment, is used to store various types of support information that is used by the system 201 to generate the Labstory documents. The information stored in the Evidence database 261 includes a list of procedure/test codes and other codes, one or more definitions for each code, a set of queries containing query criteria that correspond to the one or more definitions of each code, a list of contents links or data sources that are identified using the corresponding set of queries, etc. The structure and specification of the various types of information or data elements stored in the Evidence database 261 are described in detail below. The Evidence database 261 can be any type of storage medium including disk, tape, etc. In one embodiment, the Evidence database 261 is configured as a relational database containing a set of various tables used to store various types of information associated with the various codes as described above. However, the teachings of the present invention are not limited to relational database structures and can equally apply to any other database or file structures including flat file structure, indexed file structure, hierarchical database structure, distributed database structure, object database, or any combinations thereof, etc.

In one embodiment, the Labstories database 265 is configured to store a list of Labstory documents generated by the system 201. Each Labstory document can have a unique identifier. The Labstory documents stored in the database 265 can be accessed by the healthcare providers 220 via the application server 255. Accordingly, a healthcare provider can access not only a Labstory generated for the most recent procedure/test performed for particular patient but also previous Labstory documents generated for a particular procedure/test and/or previous Labstory documents generated for a particular patient. As such, the collection of the Labstory documents generated for each type of procedures/tests and/or for each patient can represent the statistical information concerning a particular procedure/test. Similarly, the collection of the Labstory documents can represent a patient's health history. The labstories database 265 can be any type of storage medium including disk, tape, etc. In one embodiment, the Labstories database 265 is configured as a relational database containing a set of various tables used to store various types of information including user personal and profile information, Labstory documents generated for each procedure/test for a patient, etc. The teachings of the present invention, however, are not limited to relational database structures and can equally apply to any other database or file structures including flat file structure, indexed file structure, hierarchical database structure, networked database structure, or combinations thereof, etc.

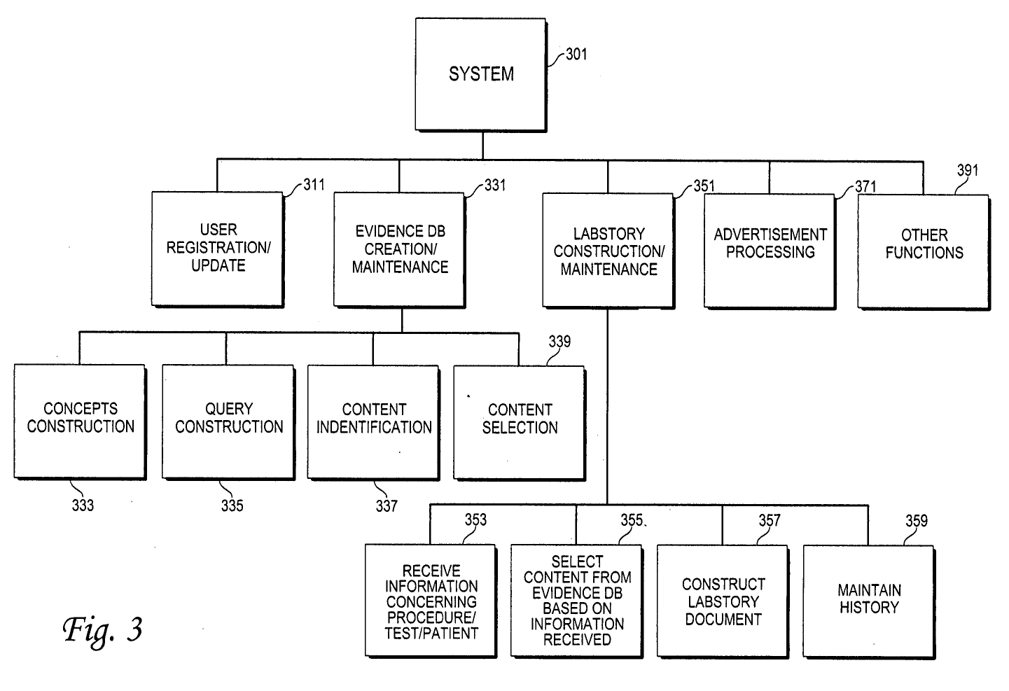

FIG. 3 shows a functional block diagram of one embodiment of the system 201 described above with respect to FIG. 2. It will be recognized and appreciated by one skilled in the art that the following description is for illustration and explanation purposes and does not limit the scope of the present invention. In one embodiment, the logic and/or functions that are described below can be implemented using one or more programming languages suitable for the software or system development in a client-server environment, such as Visual Basic, C++ or Java, etc. It should be recognized by one skilled in the art, however, that the logic or functions described herein can be implemented by other programming languages, circuits, or techniques in accordance with the teachings of the present invention without loss of generality.

Continuing with the present discussion, the system 301 includes a user registration/update logic or function 311, a logic or function 331 for creating and maintaining the Evidence database, a logic or function 351 for generating and maintaining the Labstory documents, advertisement/branding processing logic or function 371, and other processing logic or functions 391. The user registration/update logic 311 includes logic to allow the various users of the system to register with the system, to establish and maintain their user profile and identification information, etc. In one embodiment, the user profile and identification information may include the user personal and/or business contact information, unique identifier corresponding to the user, etc.

The Evidence database creation and maintenance logic 331 contains logic to create and update various lists of content links associated with each code stored in the Evidence database. The process of building and updating the Evidence database is described in more details below. In one embodiment, the logic 331 contains concept construction logic 333, query construction logic 335, content identification logic 337, and content selection logic 339. The concept construction logic 333 is used to identify or determine one or more concepts (definitions) associated with each code stored in the database. The query construction logic 335 is used to generate a set of queries corresponding to the one or more concepts associated with each. The content identification logic 337 is used to identify a potential list of data sources or content links that may contain relevant information relating to the definitions or concepts associated with each code. In one embodiment, the identification logic 337 includes logic to search various databases available on the World Wide Web to identify a potential list of documents, content links, or data sources using the set of queries generated by the query construction logic 335. The content selection logic 339 includes logic to review the potential list of data sources identified by the content identification logic 337 and select therefrom a list of data sources to be stored in the Evidence database, based upon various selection criteria including the quality and relevancy of the documents, ranking of the site or database from which the documents are retrieved, ranking or reputation of the sources of the documents, etc.

The logic 351, in one embodiment, includes logic 353 to receive and organize information about the procedures/tests and the patients received from the various sources including the healthcare service providers, the healthcare providers, etc, logic 355 to select the appropriate information (e.g., list of content links) from the Evidence database corresponding to a set of queries generated based upon the information about the procedures/tests received from the various sources. The logic 351 further includes logic 357 to construct the Labstory document that contains the information retrieved from the Evidence database. In addition, the logic 351 may include logic 359 to maintain a statistical database for various procedures/tests and patient's health history by maintaining the Labstories in the Labstories database.

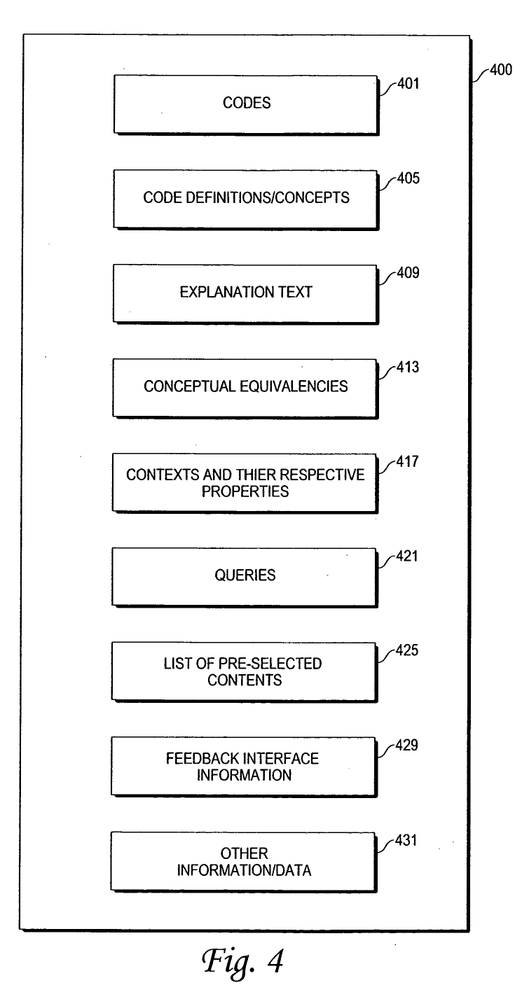

FIG. 4 shows a structure diagram of one embodiment of the Evidence database 261 described in FIG. 2 above. As illustrated in FIG. 4, the Evidence database 261, in one embodiment, is configured to store code information and related information which include a list of codes 401. The codes 401 are described in more details below. For each code 401, the Evidence database is configured to store a code definition or code concept 405, an explanation text 409, conceptual equivalencies 413 (also referred to as alternative, additional, supplemental or equivalent definitions herein), contexts and their respective properties 417, a set of queries based upon the code definition, the conceptual equivalencies, and applicable related or contextual information associated with each code, a list of selected contents or data sources associated with each code, feedback information, etc. The various types of information or data elements associated with each code are described in greater detail below. As explained above, in one embodiment, the Evidence database 261 is implemented as a relational database structure and the various types of information stored in the Evidence database 261 can be organized and maintained in various tables that can be cross-referenced or linked together using certain data items stored as keys or descriptors. The Evidence database 261, however, is not limited to relational database structure and can be implemented in any other database or file structure including flat file, indexed file, hierarchical database, networked database, etc. or any combinations thereof.

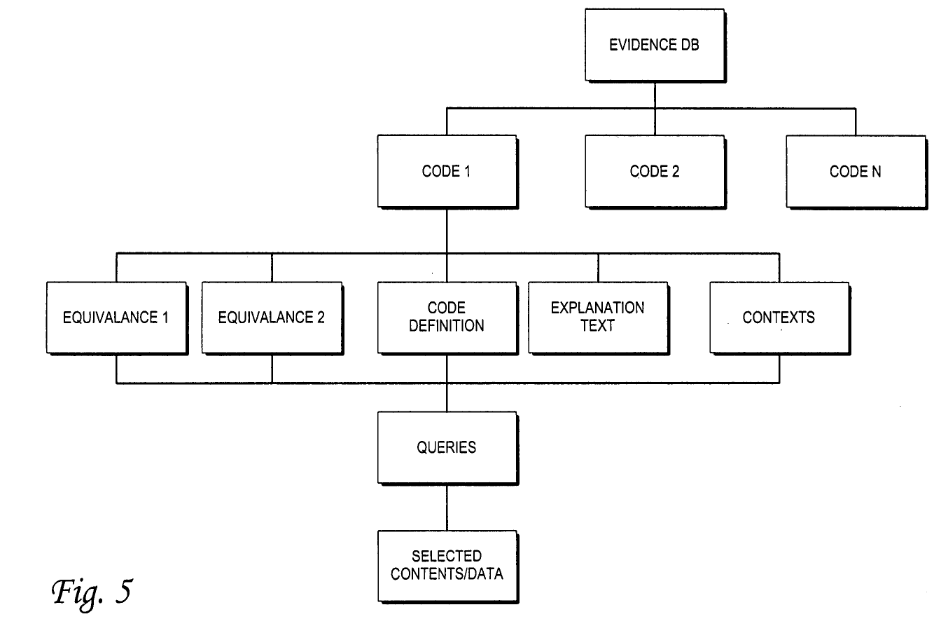

FIG. 5 shows a tree view diagram of one embodiment of the Evidence database 261 with respect to some of the information maintained therein. For example, a code identified as code 1 (e.g., one of the codes stored in the database 261) may have various types of associated information that are also stored in the database 261. As shown in FIG. 5, each of these types of information can be associated with the respective code using some identifiers, for example a unique code identifier or code number corresponding to the respective code. Each of the codes stored in the database 261, for example code 1, may have one or more code definitions and other information associated with it. For example, as shown in FIG. 5, code 1 has one corresponding code definition, one explanation text, one or more context fields, two alternative definitions or conceptual equivalencies, one set of queries constructed based upon the definition and the conceptual equivalencies corresponding to the respective code, and a list of pre-selected contents or data sources that are obtained using the corresponding set of queries. As described herein, the codes stored in the Evidence database 261 may include the procedure/test codes according to the Current Procedure Terminology (CPT) that are used to identify or indicate the particular procedures/tests, diagnosis codes according to the International Classification of Disease (ICD) that are used by the healthcare providers to report diagnoses, conditions, symptoms, signs, injuries, adverse drug effects, and other situations. Other codes can also be used, including “order codes” which are specific of a given clinical laboratory and used to identify tests and process the business orders. For example, the CPT code for a “Free Thyroxine” dosage is “84439”, the ICD-9-CM code “466.1” corresponds to “bronchiolitis”. As another example, the ICD-9-CM code “375.32” is used to indicate a condition or problem known as “Acute Dacryocystitis” The alternative definitions or conceptual equivalencies of this code include, for example, “tear duct infection” and “tear sac infection”. For this particular code, the following contexts or contextual information may be useful to identify more relevant and more targeted information regarding the condition/problem indicated by the respective code: (1) whether the patient is an infant, (2) whether the patient is a child, etc.

In one embodiment, a data source or content link associated with the code may be referenced by a file name or an address of a location at which the respective data source resides. In one embodiment, the data source can be referenced by a URL. The data source can contain text data, graphics data, voice data, video data, or any combination thereof.

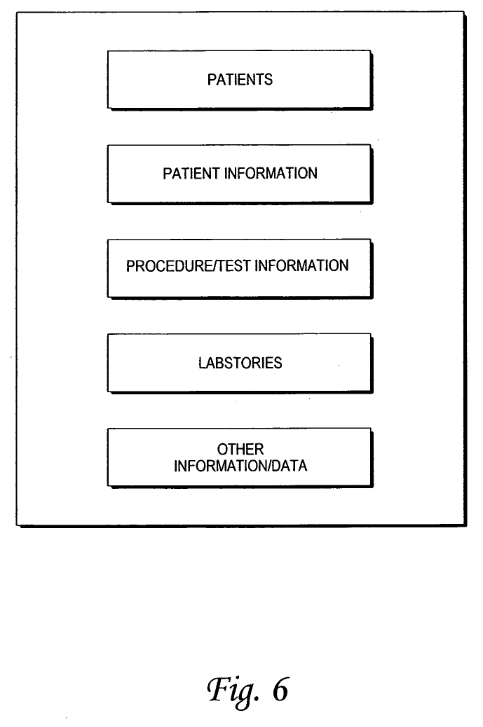

FIG. 6 shows a structure diagram of one embodiment of the Labstories database 265 described in FIG. 2 above. As illustrated in FIG. 6, the Labstories database 265, in one embodiment, is configured to store the procedure/test information, patient information and the Labstories generated by the system 201. In one embodiment, the database 265 may contain a list of patients that can be uniquely identified using some unique identifiers such as social security numbers, or unique user identifier assigned by the system, etc. Information about each patient such as patient personal information, profile, etc. may also be stored in the database 265. For each patient, the database 265 is also configured to store the Labstories generated by the system. In one embodiment, the database 265 may contain a list of procedures/tests that can be uniquely identified using some unique identifiers such as the CPT codes or unique identifiers assigned by the system, etc. For each procedure/test, the database 265 is also configured to store the Labstories generated by the system with respect to that particular procedure/test. The Labstories stored in the database 265 for each patient can collectively represent the patient's health history. Similarly, the Labstories stored in the database 265 for each procedure/test can represent a statistical database for that particular procedure/test. Other types of information concerning the patients may also be stored in the database 265 including patient's benefit information, etc. As explained above, in one embodiment, the Labstories database 265 can be implemented as a relational database structure and the various types of information stored in the database 265 can be organized and maintained in various tables that can be cross-referenced or linked together using certain data items stored as keys or descriptors. The database 265, however, is not limited to relational database structure and can be implemented in any other database or file structure including flat file, indexed file, hierarchical database, networked database, etc. or any combinations thereof.

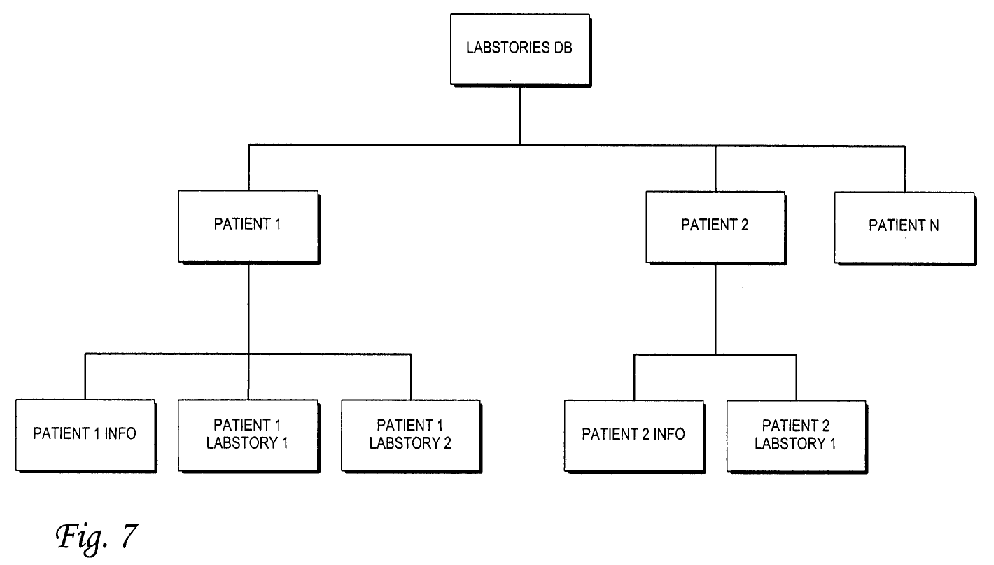

FIG. 7 shows a tree view diagram of one embodiment of the Labstories 265 with respect to some of the information contained therein. In one embodiment, the database 265 is configured to store a list of patients and relevant information associated with each patient. The information associated with each patient stored in the database 265 may include the patient's personal and profile information, patient's identification information, etc. The patients can be uniquely identified by some unique identifiers such as social security numbers or unique user identifiers, etc. There can be multiple Labstories stored in the database 265 for each patient. For example, patient 1 has two Labstory documents that were generated by the system for him/her. Accordingly, for each patient identified in the database 265, the patient's health history can be represented by the collection of the patient's Labstories stored in the database 265. The process of generating the Labstories is described in more detail below.

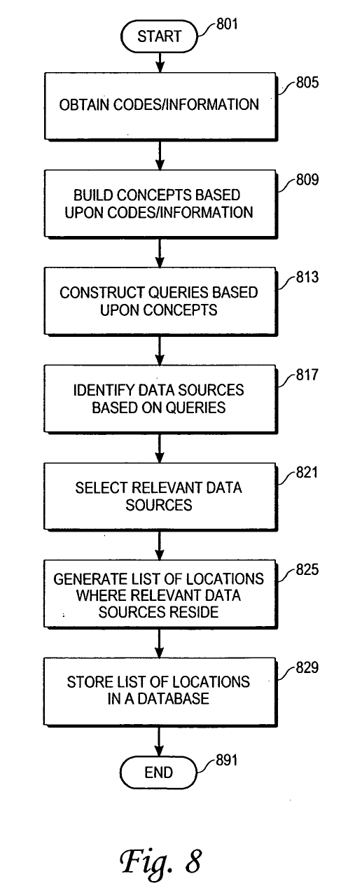

FIG. 8 shows a flow diagram of one embodiment of a process for building an Evidence database. As mentioned above, the Evidence database is a repository (flat file, hierarchical, relational, object-oriented, object-relational or distributed object-oriented databases as examples) of schema representing, for example, content documents, pages or URLs containing text, audio, video, images or any other media, chat rooms, newsgroups, communities and other Internet-based forums, that are associated with given codes and other information used in the health care delivery chain. The Evidence database allows for the selection of highly pertinent documents, the access to which does not require any search on the part of the user.

As shown in FIG. 8, the process starts at block 801 and proceeds to block 805. At block 805, various codes and/or other types of information according to some classification schemes (e.g., Current Procedure Terminology) are identified to be used for the building the Evidence database. At block 809, various concepts/definitions/descriptions corresponding to the codes are determined. At block 813, a set of various queries is constructed based upon the concepts associated with each code. At block 817, various potential data sources or content links are identified using the queries constructed at block 809. At block 821, these potential data sources are reviewed for quality, relevancy, appropriateness, etc. and a subset of these potential data sources is selected therefrom. At block 825, a list of locations where the selected data sources reside is generated. The process then proceeds to block 829 to store the selected list in the database for the corresponding code. The process in FIG. 8 is described in more detail below.

It should be noted that various types of information (diagnoses, problems, procedures, drugs, tests and others) and codes can be used to build concepts. An example of such codes are codes from the CPT and the ICD-9-CM classification of diseases, used by providers to report diagnoses, conditions, symptoms, tests, procedures, signs, injuries, adverse drug effects and other situations.

Code Concepts or Concept Representation

The following discussion can be applied to any diagnosis, procedures, laboratory tests, injections, materials and supplies, problems or other category of information that accompanies medical visits. For purposes of explanation and illustration, the discussion below is focused on the usage of CPT and ICD-9 (International Classification of Disease, 9th revision), or ICD-9-CM (International Classification of Diseases, 9th Revision, Clinical Modification, developed by the National Center for Health Statistics) codification of diseases, used to report diagnoses or problems to health care organizations (e.g., the insurance report shown in FIG. 13). The 10^{th} revision of the ICD is also available. The ICD-10-CM (Clinical Modifications) is expected to be in use in the United States in 2001. ICD-10 is already in use in other countries.

The process described herein can apply to any of these classifications, as well as others including, but not limited to, HCPCS codes (HCFA Common Procedure Coding System), or READ codes (in the U.K.).

For any area of medicine or healthcare practice (e.g. Pediatrics, Obstetrics-Gynecology, Family Practice, Internal Medicine, etc.), the procedure/test codes and diagnosis (and other) codes can be turned into “concepts” as follows:

Conceptual Equivalencies

Each code's definition can be translated or expanded into a “concept” that represent its meaning in different forms. For example, the CPT code for a “Free Thyroxine” dosage is “84439”. The associated concept may contain the “F-T4” denomination. For example, in the ICD-9-CM classification, code “466.1” may be used to indicate “bronchiolitis” in the ICD-9-CM classification. In its conceptual equivalence one may find “RSV” or “Respiratory Syncytial Virus”, a major cause of “bronchiolitis”. Another example is “Gastroenteritis” or “Infectious Diarrhea”, code “009.2”, also commonly called “Stomach Flu”. “Stomach Flu” therefore becomes part of the concept associated with the ICD-9-CM code 009.2. Another example, is “Hashimoto's disease”, coded as “245.2”, which may also be called a “chronic autoimmune thyroiditis”. This translation of the original code into a richer concept is used for the construction of an EDB database, since the database contains the results of searches based on both the definition and the equivalencies of any given code.

Contexts

Each type of information, code, equivalence or other data may be associated with one or more “contexts” to characterize it further. For example, “sex” may be important with respect to “UTI” or “Urinary Tract Infection”, code “599.0”, or in regards to a CPT code such as “83001” for the dosage of the “Gonadotropin” or “Follicle Stimulating Hormone” (equivalency).

Each code and each code concept may thus be associated with one or more values for contextual information (e.g., Child, Male, Asthma, etc.). Contexts can be defined or implemented as any structure (for example, a simple term, a database scheme, an object, a concept or other). In one embodiment, if there is more than one context, they can all be ranked by level of importance or weight or any ranking order otherwise defined. The definition of contexts may contain additional properties. Any specific algorithms can be implemented to take such properties into account when using the database to derive Evidence database contents in a particular situation. In addition, contexts may be associated with operational definitions. For example, infant may be defined by 0<age<18 months old. Operational definitions may include other codes. Contexts may also point to specific documents or services. For example, code “034.1” for “Scarlet Fever” may have a context named “Compliance” to which may be attached a text, a URL, graphic or executable program to emphasize the need to comply fully with the 10 consecutive days of antibiotics course required, even though all symptoms may have already disappeared after only a few days of antibiotherapy.

Contexts may also be other codes. For example, the concept representing CPT code “84443” for a TSH (Thyroid Stimulating Hormone) test may well have as a context the notion of pregnancy represented by the ICD-9-CM code “V22.2”. As another example, the concept representing ICD-9-CM code “642.9” for “hypertension complicating a pregnancy and of unspecified origin” may have CPT code “84443” as a context. A context can also be a generalization, such as, for example, “thyroid” for a concept representing one specific thyroid function test. Contexts may be result qualification such as “low” or “high”. In general, contexts may be any other criteria or term that can be used to identify the relevant information as described later.

Conceptual Queries

The resulting database or list of code concepts allows for the formulation and execution of conceptual queries against any type of database. The discussion in this example refers to web-based databases.

Consider a database site called “XYZMed” accessible using the following URL:

http://www.XYZMed.com/cgi-bin/search?queryText=.

Using the code concepts defined above, one can construct a series of queries into the database. For example, CPT code “86800” may be associated with the following concept:

Code: 86800

Name or Definition: Thyroglobulin Antibody

Equivalencies: “TGAb”, “Antibody-thyroglobulin”, “autoimmune thyroid antibodies”0

Context: pregnancy, thyroid, etc.

For each name, version of the name, or equivalence, a query is generated as well as queries augmented with contextual information. If contexts are non-exclusive, there will also be combinations of contexts. For the example above, the resulting queries may include the following:

http://www.XYZMed.com/cgi-bin/search?queryText=Thyroglobulin+Antibo-dies

http://www.XYZMed.com/cgi-bin/search?queryText=Thyroglobulin+Antibo-dies+

Pregnancy

and other combinations. If the context had been ICD-9-CM code “V22.2”, then the conceptual representation of the code would have been used to generate the queries also.

In this example, the above queries are direct http queries. However, any type of query can be supported, with a different syntax, different logical operators (e.g. “or”), different access methods (e.g. an HTML form), or other modalities.

Searching for web documents using only the CPT, ICD-9-CM or ICD-10 definition is not sufficient. Indeed, many procedures, tests, diagnoses, conditions or problems are represented differently in non-medical settings. Thus, switching from the original definition to a richer conceptual representation allows for effective and efficient queries in a large variety of databases.

Content Identification and Selection

To each of the conceptual queries is then associated a list of contents or data sources that are identified in a specific database using the corresponding query. The review and selection process to select appropriate documents or data sources to be included in the Evidence database, while “manual” in nature, could be replaced or enhanced by algorithmic techniques. The quality and relevance of each query is assessed and a resulting set of identified documents is selected. The selection process can be manual, by reading the document and assessing their quality. It could also use automated algorithms, or involve other criteria such as ranking of the site or database where the document resides, ranking of the source of information, etc.

Any categories of sites may be considered in the case of using the web. This may include, but is not limited to, the following:

Service provider web site or database

Government databases

Associations

Medical literature

Medical databases

Medical journals

Specialized Application Services (for example, but not limited to, Algorithms, Risk Assessment Tools, Modeling Tools)

Health Plans and Managed Care Organization services

If there are adequate documents using any of conceptual queries for a particular code, with or without contextual information, they can be selected with their respective contexts to which weights may also be assigned.

For example, the query:

http://www.XYZMed.com/cgi-bin/search?queryText=TSH+pregnancy may yield a document or a link to a document “A” that is deemed useful (manually or by other methods). “A” (or its link, address, or reference) is then added to the Evidence representation for the ICD-9-CM Code Concept “V22.2” combined with the CPT code “84443”. The URL for “A” may look like: http://www.XYZMed.com/A.

A document can be of any nature. For example, the link:

http://www.nlm.nih.gov/medlineplus/thyroiddiseases.html points to a specialized “portal” on thyroid diseases at the National Institute of Health web site. As other examples, the link:

http://wwww.endo-society.org/maternalthyrroiddeficiency/index.htlm points to a specific document on maternal thyroid deficiency at a medical society.

As another example, the query:

http://www.XYZMed.com/cgi-bin/search?queryText=ECG+Syncope+child may yield a document “B” deemed useful. “B” is then added to the EDB representation for the CPT code “93000” with the context ICD-9-CM Code Concept “780.2”, along with the site (XYZMed) and the context “child”. “ECG” points to a CPT code object with its own properties.

Furthermore, the “content” may be dynamic and constantly changing. An example is content represented as a query (rather than a link) which is included as such in the Labstory and executed when the end user (health care provider) decides to do so. It may yield different results at different times, by definition. An example of such query may be as follows using the National Institute of Health's PubMed database of medical literature:

http://www.ncbi.nlm.nih.gov/cgi-bin/Entrez/clinical?Strategy=diagnosis&precision=specific&term=TPO+thyroid&submit=Search

Such queries can be optimized so as to yield, for example, only the most recent literature, from certain journals or institutions. In addition, methods can be attached to the database to continuously monitor the validity of links, the availability of documents, or changes that may occur in the execution of any and all queries used to build the database.

Hence, the Evidence database may contain, for example:

For each CPT code (or other code):

The code

The code definition (e.g., official definition)

An explanation text

The Conceptual Equivalencies

The Contexts (including ICD-9-CM codes) and their respective properties (e.g., weights)

A set of queries into various databases or sites

A list of pre-selected contents or data sources annotated with the contexts and their weights and other properties if any, as well as the corresponding ICD-9-CM codes if any.

A set of related application services or supporting information to estimate risks or help interpret the data or results

A Feedback Interface Information

Other information or functions

Accordingly, codes (e.g., CPT codes or ICD-9-CM codes) can thus be transformed into objects with the above properties. Classes of codes and their conceptual representation can be created, as well as functions and methods operating on them.

The above list of fields or properties is not exhaustive and is extensible. It can be enhanced with many more aspects of any “Code Concept”. For example, a property could be reserved for “Therapeutic Management” information. In the case of a CPT or ICD-9-CM code for a procedure, a property could be reserved for “Preparation”. In the case of an NDC code for a drug, a series of properties could address drug-related properties.

The content associated with any CPT code and/or ICD-9-CM-code, after selection, can be represented as a tree structure, where each link represents a different context associated with the code under consideration. If a particular context applies when matching procedure/test and/or patient information to the information in the database, then the content it points to can become a candidate for inclusion in the service delivered to the patient or consumer.

For Example

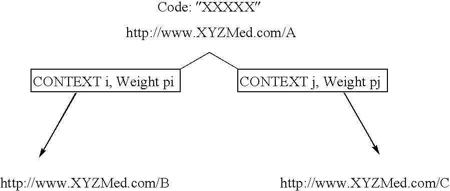

In this example using CPT codes, each code is transformed into a concept code leading to conceptual queries and the subsequent construction of such a “tree”.

The database can be stored in any format and any query language or program can be used to query schema information from the database, including but not limited to Java, Java script, Java applets, HTTP servlets, IIOP, CGI, or SQL.

Other Augmenting Information Other information can be indexed in the EDB, contributing to augmenting the reporting of lab or procedure results in the proper context. They include, but are not limited to the following categories:

Health Plans

Information from the patient's health plan includes all available information on the patient's record, including but not limited to explanations of benefits, referral services, and others. An important contribution of health plan is made of specific programs regarding certain tests, procedures, diagnosis and treatment. Such programs may include test or treatment guidelines, risk management programs, and others. These types of information may be based on outcome studies, intervention programs or other sources and contribute to the education, compliance and other elements in the relationship between the different players in the healthcare delivery chain. The Labstory allows for their highly targeted delivery and considerably increase their efficiency.

For example, a program designed to help expecting women receive certain benefits and information can be referenced or indexed in the EDB under the code V22.2 and others related to pregnancy. This will allow the automatic inclusion of this program when a relevant case is presented to the database.

Provider Organizations

The provider organization that the physician belongs to may also have information relevant to the patient. It might be tracking local health data and news, provide community health news, and other functions. Provider Organization may also have their own intervention program equivalents, to increase quality of care and reduce costs.

The information related to those organizations can be made available by direct connection into the proper database or by connecting to an existing interface.

Service Providers Information

Service and laboratory testing providers can use the Labstory to communicate with health care consumers in different ways (e.g. specific information, newsletters, corporate news).

Other Organizations

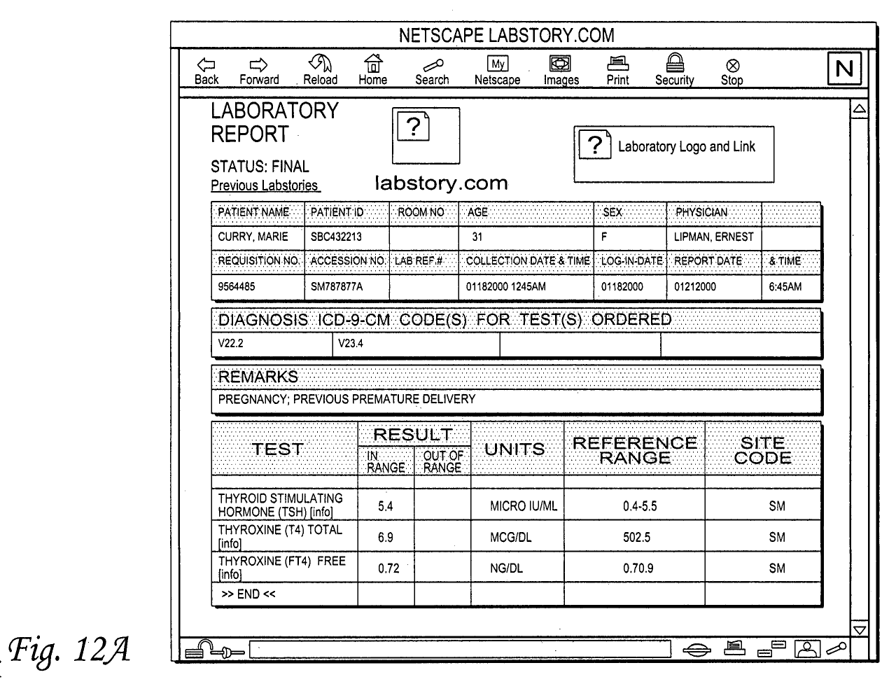

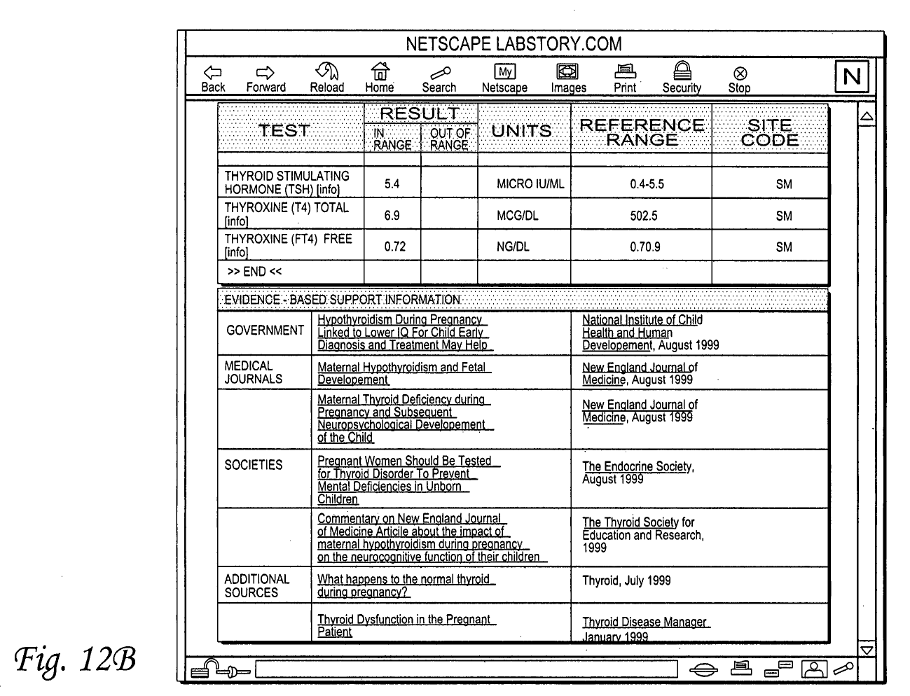

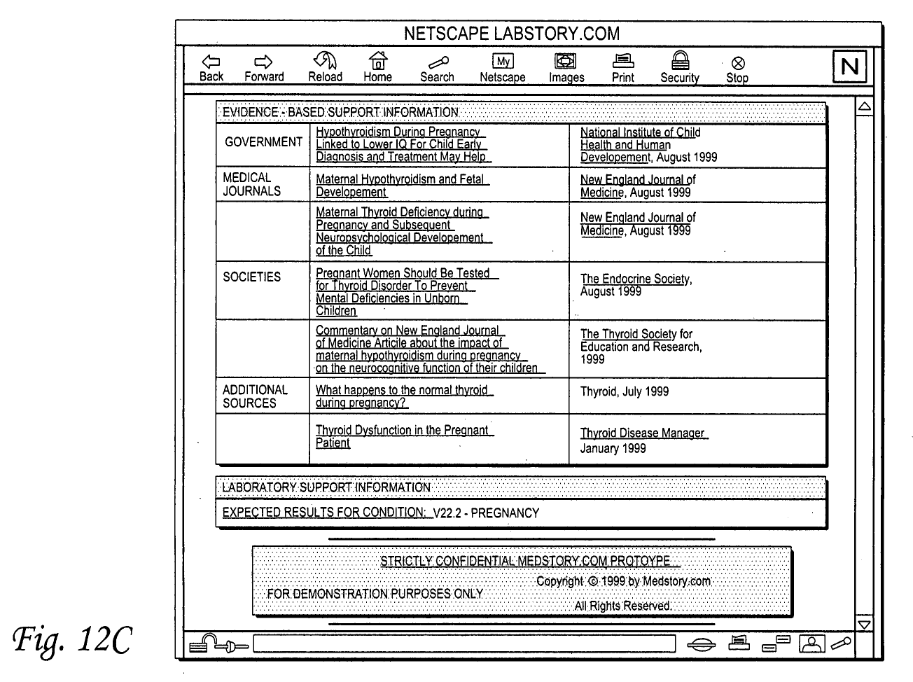

Labstory can be used as a vehicle for pertinent and targeted messages from other organizations, without limitation. This includes, for example, public health organizations or medical associations. A medical association example is illustrated in the table of evidence-based support information of FIGS. 12B-C.

Provider Longitudinal Information

As service providers log in requests from the various healthcare providers, they may be able to analyze the patterns or profiles of activity of each healthcare provider with respect to the services performed and the reasons for such services. The Labstory represents unique vehicle to provide information about or derived from such analyses to their customers (providers).

Patient Longitudinal Information

Furthermore, patient-specific information can also be tracked, allowing for a Labstory to provide access to the patient's history with respect, for example, to a particular test. Previous tests, at different time periods can be plotted and the evolution visualized by the provider.

Medical Services Management and e-Commerce

Specific information on the requirements of repeat or additional procedures may be included to help physicians manage the services in relation to each patient.

Other Services

Other services may be added to, or integrated into the Labstory, including, but not limited to, health risk assessment, health tracking and calendar (e.g. pregnancy course), e-commerce related to the services. The integration can be done through any application programming interface (API) or any other mechanism.

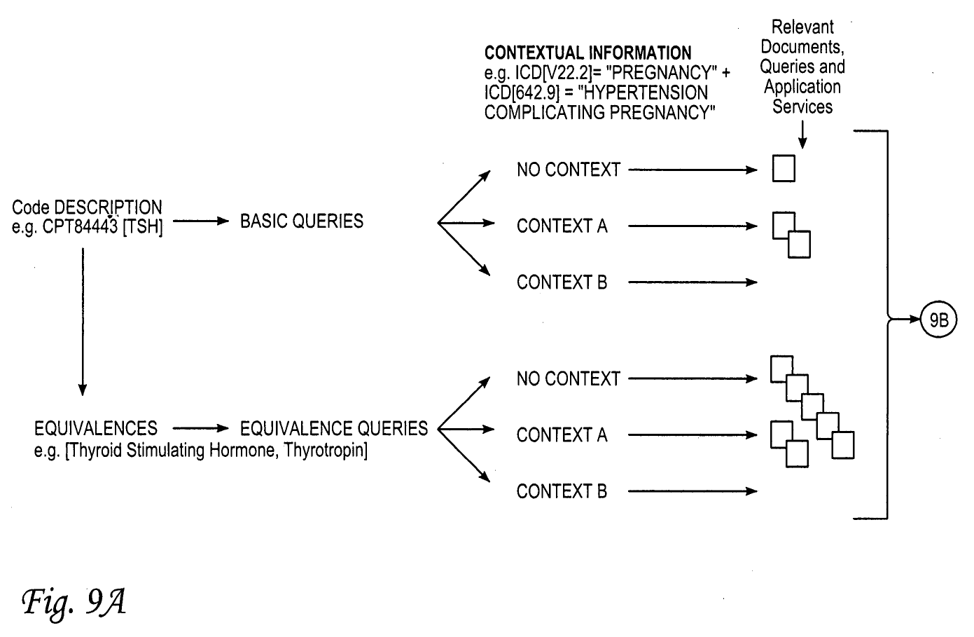

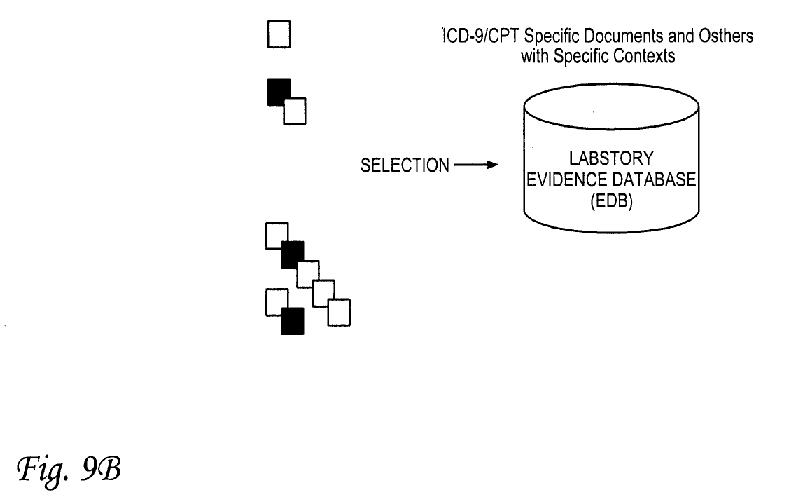

FIGS. 9A and 9B illustrate a block diagram of one embodiment of a process for building the Evidence database as described above with respect to FIG. 8. As shown in FIGS. 9A and 9B, a CPT code may have one definition (e.g., “TSH” in this example) and multiple alternative definitions or equivalencies (e.g., “Thyroid Stimulating Hormone”, “Thyrotropin”, etc.). The basic queries are constructed based upon the definition associated with the given code. Likewise, the equivalence queries are constructed based upon the alternative definitions or equivalencies associated with the given code. As shown in FIGS. 9A and 9B, some of the queries constructed may then be augmented with applicable contextual information to generate queries having contextual information as part of the query criteria. The various queries are then used to perform search into various web databases to identify documents or data sources that match the query criteria specified. These potential data sources are then reviewed and a subset of these may be selected based upon various selection criteria to generate a list of data sources to be included in the Evidence database for the given code.

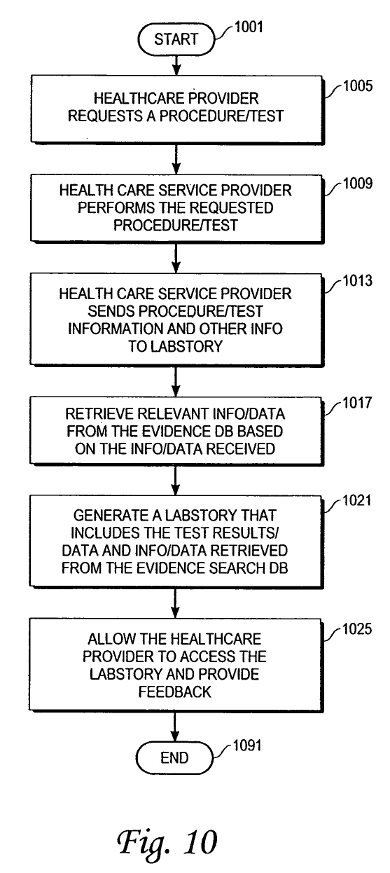

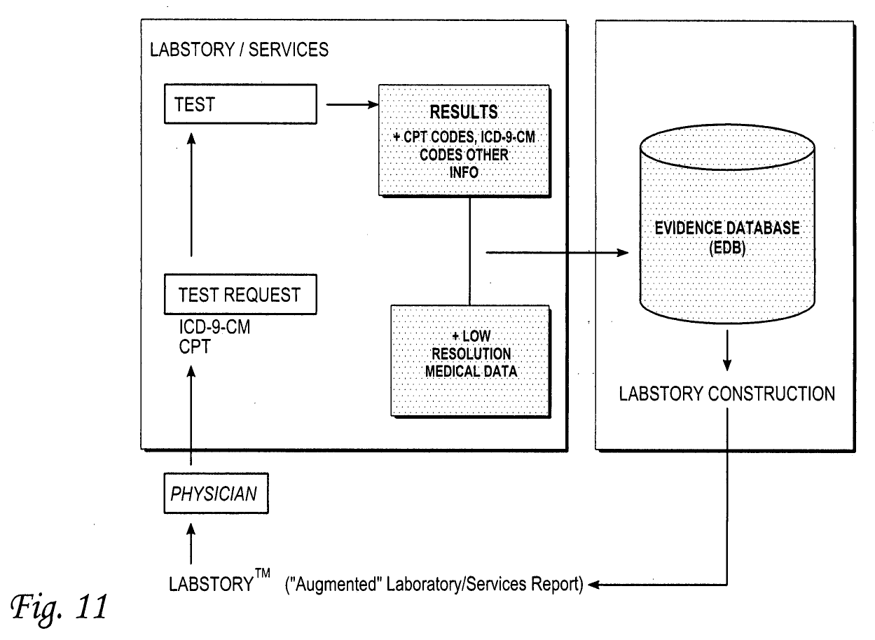

FIGS. 10 and 11 show a flow diagram and block diagram, respectively, of one embodiment of a process for generating a Labstory following a procedure/test. At block 1005, a healthcare provider (e.g., a physician) submits or orders a procedure/test request to a healthcare service provider (e.g., laboratory). At block 1009, the service provider performs the procedure/test requested by the healthcare provider. At block 1013, the healthcare service provider (e.g., laboratory) sends procedure/test information including CPT code(s) and test data and results, and other types of information including diagnosis information and other appropriate information to the Labstory system. The diagnosis information may include diagnosis codes and other types of information including injections, materials and supplies, etc. Other types of information may include patient medical information such as gender, age, weight, height, prescription, etc. At block 1017, the information received from the healthcare service provider is used to retrieve from the Evidence database appropriate information (e.g., a list of data sources) that corresponds to a set of queries constructed or selected based on the information received. At block 1021, a Labstory document is generated which contains the information retrieved from the Evidence database. At block 1025, the healthcare provider (e.g., the physician) is allowed to access, via the Internet or other methods of communications, the Labstory generated. The physician is also allowed to provide feedback to the system using one or more interfaces provided to him by the system which can be in various forms depending upon the particular implementations of the present invention. The process shown in FIG. 10 is described in more detail below.

In one embodiment, the construction of a Labstory document involves different interactions between different entities or sources, databases and other components of the system. Some information may not be obtained immediately, such as benefits-related information. Thus, the system may receive information from different entities at different times. When information about the procedure/test and the patient is available following the performance of a procedure/test, the system then uses the information available to query the Evidence database to retrieve relevant information and generates a Labstory document.

The Labstory document can be constructed in any language, including, but not limited to HTML and XML, and support various types of extensions, plug-ins or other technologies. As an example, handheld devices may require use of other languages such as WML (Wireless Markup Language). Other specifications or protocols would be used to describe Labstory in a television or set-top environment, or other environment.

Sources of Information

As mentioned above, various sources and entities may provide various types of information and data that can be used by the system to generate a Labstory document. These various entities may include the healthcare providers, the healthcare service providers, the IPA, medical group or other provider organizations, the health plan, insurer or health care organizations, government organizations, etc.

Transmission of Information from the healthcare provider (e.g., physician) or service provider (e.g., laboratory)

Information about the procedure/test, diagnosis, patient, etc. can be transmitted to the system by any acceptable means, including phone, fax or via the Internet/world-wide web or other networks. Internet connections can use secure http (https) and other technologies and policies as needed to provide the necessary security, confidentiality and privacy.

Provider-Specific Profiles

The construction of a Labstory may be driven by provider-specific profiles, in which providers are able to indicate what category of information they prefer. Certain categories of information may also be determined automatically by analyzing data from previous interactions with the provider.

Provider Information

Information provided to the system may include:

Provider Name

Provider ID

Phone number

Office visit date

Other provider information

Patient Information

Patient information may be received from the physician's office or any other source in the health care delivery chain. It may include any combination of the following or others:

Patient name

Identification Number

Patient DOB (Date of Birth)

Sex

Health Plan

Provider Association

Diagnosis information and other types of information about the patient can be transmitted to the system. Such information may include the following:

ICD-9-CM Diagnosis Codes, NDC Codes and/or drug names, etc.

Other Codes

Low resolution medical information (e.g. weight, height, blood pressure, etc.)

Prescription information for prescription drugs and over-the-counter drugs, materials, supplies or other physician-provided information or recommendations (e.g. counseling, education, diet, exercises, or other therapeutic services)

Comments from the Physician Provider (in any format including text, video, audio, etc.) Other types of information (e.g. vaccinations, procedures, pre-conditions, risks) can be included as well.

Evidence Database Content

In one embodiment, when the information about a procedure/test and a patient is available, the Evidence database can be used to determine which Evidence content or content links to include in the corresponding Labstory. As described above, the Evidence content may be relevant to any aspect of the information provided about the procedure/test and the patient (e.g., diagnosis codes, prescription drugs, non-prescription drugs, tests, and others).

In one embodiment, the Labstory document makes uses of a certain number of Evidence links to provide information on procedures/tests, diagnoses, drugs and other matters. If that number is less than the number of sites for which the database has Evidence links for the particular code, then a site ranking mechanism may be used to select, for example, five sites to be represented. Sites can be web-based sites, medical or not, informational, e-commerce or any other content repositories.

In one embodiment, site rankings may be based upon various criteria including the result of editorial choices, the patient's health plan (if the company or organization maintains a relevant information database), preferences or feedback information from the healthcare provider, preferences from the healthcare provider, and other factors that may be included. Site rankings may be determined or modified manually or using algorithms and automated methods.

In one embodiment, content links may be referenced by specific addresses corresponding to locations where the content sources reside. In the world-wide-web context this may be represented by a URL, a CGI query, a form or other methods of representation.

As an example, consider the following “tree” in the Evidence database for a particular CPT Code called “xxxxx”, as described earlier.

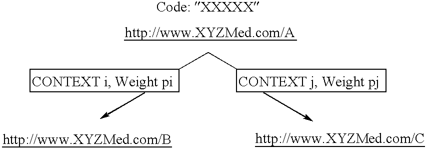

In one embodiment, the matching process to select appropriate content links can be performed as follows:

If the only information provided on the procedure/test is the code “xxxxx”, and no context is determined, then the EDB link that will appear on Labstory, for the site “XYZMed.com” will be: http://www.XYZMed.com/A

If one of the two contexts can be determined then the EDB link that will appear on Labstory, for the site “XYZMed.com” will be: http://www.XYZMed.com/B, or http://www.XYZMed.com/C.

In one embodiment, if the two contexts can be determined, then the EDB link that will appear on Labstory, for the site “XYZMed.com” will be the link associated with the context that has the highest weight. If weights are equal, a strategy such as using the first one can be used. In another embodiment, both links will be presented to the patient.

Other algorithms can be designed to search the trees of links, or match cases to the EDB. For example, site or databases rankings, can be used to choose between two equally important links. Criteria such as site rankings may be determined or modified manually or using algorithms and automated methods. The patient's health plan, preferences or feedback information from previous interactions with the provider, and other factors that may be introduced that can contribute to selecting links or references. If an ICD-9-CM or a CPT code, for example, has no associated EDB links in any sites according to the EDB database, the parent code can be used as a substitute. For example, if code “034.1” for “Scarlet Fever” is not in the database, the parent code “034.” for “Streptococcal sore throat and scarlet fever” is then looked up. Another mechanism may be to look for any other code the conceptual definition of which intersects with the definition of the missing code. For example, “034.0” is defined as “Streptococcal sore throat” in the ICD-9-CM classification. Its conceptual definition could be, in one embodiment:

Code: 034.0

Name: Streptococcal sore throat

Equivalencies: “Strep Throat”, “Scarlet Fever”

Context: infection, rash [“Scarlet Fever”]

Hence, Streptococcal sore throat with a rash context could lead to Scarlet Fever EDB links. By searching through the equivalencies, the appropriate concept can be identified and used to generate the appropriate EDB links. Other algorithms can also be used.

Other information which are indexed by the EDB are also included in the Labstory if they are relevant to information in the report and are selected by the database. For example, this may be an “intervention program” from the patient's health plan.

Dynamic Labstory Content

Labstory documents can be modified over time. For example, benefits information may be added to the document as they are generated by the health plan. This may possibly take place after another subsequent visit to the physician has already occurred, for which another Labstory was generated. In another example, the document contains specific services related to further test or screening management and keeps the physician and patient informed of key dates, appointments or other functions.

Hence, a Labstory document is a “dynamic” document undergoing changes as new information is acquired by a variety of means.

Transmission of a Labstory from the Laboratory or Medical Service to the Physician or Provider

The Labstory can be transmitted to the provider by any acceptable means, including phone, internet phones, fax or via the internet/world-wide web or other networks. Internet connections can use secure http (https) and other technologies and policies as needed to provide the necessary security, confidentiality and privacy. Different media support can use different underlying formats to represent the information (for example, WML for internet-enabled phones).

The Labstories Database

Each Labstory constructed can have a unique identifier and can be stored in a database. As described above, the Labstories database is a repository (flat file, hierarchical, relational, object-oriented, object-relational or distributed object-oriented databases as examples) of schema representing individual Labstory documents. Queries can be made via any query language or program.

Longitudinal Labstory Content

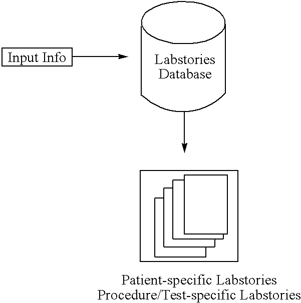

A direct consequence of the existence of this database is the ability for the user to access a collection of past Labstory documents that can be patient-specific or procedure/test-specific. The collection of patient-specific Labstory documents can represent a record of one's health history.

FIGS. 12A, 12B, and 12C illustrate an example of one embodiment of a web user interface for presenting a Lab story document that includes evidence-based or evidence-related support information, laboratory support information, and other information as described above. As shown in these figures, the Labstory generated following a procedure/test may include the following: patient and provider information, diagnosis information, test data and results, evidence-based support information, laboratory support information, etc (e.g., list of content links or data sources retrieved from the Evidence database), etc.

The invention has been described in conjunction with the preferred embodiment. It is evident that numerous alternatives, modifications, variations and uses will be apparent to those skilled in the art in light of the foregoing description. Although the invention has been described with reference to specific exemplary embodiments, it will be evident that various modifications and changes may be made to these embodiments without departing from the broader spirit and scope of the invention. Accordingly, the specification and drawings are to be regarded in an illustrative sense rather than a restrictive sense.

What is claimed is:

1. A method comprising:
at a server,
receiving information about a medical procedure performed for a patient based upon a request from a healthcare provider;
performing a query function to retrieve from at least one computer database a list of data sources based upon the received information about the medical procedure; and
generating at least one document containing the list of data sources retrieved from the at least one database, wherein performing the query function comprises
generating a set of queries containing query criteria based on the received information about the medical procedure; and
executing the set of queries to retrieve from the at least one database the list of data sources matching the query criteria, wherein generating the set of queries comprises selecting a set of preexisting queries that correspond to the received information about the medical procedure.

2. The method of claim 1, wherein the information about the medical procedure comprises at least one procedure code indicating the medical procedure performed for the patient.

3. The method of claim 2, wherein the at least one procedure code comprises procedure codes according to the Current Procedure Terminology (CPT).

4. The method of claim 2, wherein the at least one procedure code comprises at least one procedure code according to the International Classification of Disease (ICD).

5. The method of claim 1, further comprising:
receiving information about the patient including diagnosis information based upon a diagnosis of the patient performed by the healthcare provider, the diagnosis information comprising at least one diagnosis code indicating at least one condition of the patient based upon the diagnosis.

6. The method of claim 1, wherein the list of data sources includes a data source that is referenced by an address corresponding to a location where the data source resides.

7. The method of claim 1, wherein the address corresponding to the location where the data source resides comprises a Uniform Resource Locator (URL).

8. The method of claim 1, wherein the generating the set of queries comprises:
constructing a set of queries based on the information received about the medical procedure.

9. The method of claim 8, wherein constructing comprises:
determining at least one medical procedure identifier from the information received.

10. The method of claim 9, wherein the at least one procedure identifier corresponds to at least one procedure code.

11. The method of claim 9, wherein the at least one medical procedure identifier corresponds to a procedure description.

12. The method of claim 9, wherein the at least one medical procedure identifier is included in the information received.

13. The method of claim 9, wherein the at least one medical procedure identifier is derived from the information received.

14. The method of claim 9, further comprising:
determining additional procedure identifiers that are equivalent to the at least one procedure identifier included in the information received.

15. The method of claim 1, further comprising:
allowing the healthcare provider to access the at least one document via a computer network.

16. The method of claim 15, further comprising:
allowing the healthcare provider to provide at least one of feedback and comments with respect to the information contained in the at least one document.

17. The method of claim 16, wherein the computer network is selected from the group consisting of a local area network, a wide area network, and the Internet.

18. The method of claim 1, wherein the query criteria include contextual information applicable to the information received.

19. A system comprising:
a first database to store multiple lists of content links, each list corresponding to a specific medical procedure code; and
a first server to receive information about a medical procedure from at least one source, said information about the medical procedure including at least one procedure code, the first server to retrieve from the first database at least one list of content links based upon the at least one procedure code received, the first server to generate at least one document containing the at least one list of content links retrieved from the first database, wherein the first server is to select a set of preexisting queries that correspond to information about the medical procedure to retrieve from the first database the at least one list of content links.

20. The system of claim 19, wherein the at least one document generated is stored in a second database.

21. The system of claim 19, wherein the at least one document is made accessible to a healthcare provider via a computer network.

22. The system of claim 19, wherein the computer network is the Internet.

23. The system of claim 19, wherein the first server includes a machine-readable medium comprising instructions which, when executed by a machine, cause the machine to perform operations, the instructions comprising:
logic to receive the information about the medical procedure from the at least one source;
logic to generate a set of queries based upon at least one definition corresponding to at least one procedure code received; and
logic to execute the set of preexisting queries to retrieve from a first database the at least one list of content links that correspond to the set of preexisting queries.

24. The system of claim 19, wherein each list of content links stored in the first database is identified using a set of queries generated from at least one definition associated with the respective procedure code.

25. The system of claim 19, wherein the set of preexisting queries is used to search at least one database on the World Wide Web to identify a potential at least one list of content links.

26. The system of claim 19, wherein the potential at least one list of content links is used to select the corresponding at least one list of content links that is stored in the first database.

27. A machine-readable medium comprising instructions which, when executed by a machine, cause the machine to perform operations comprising:
at a server,
receiving information about a medical procedure performed for a patient based upon a request from a healthcare provider;
performing a query function to retrieve from at least one database a list of data sources based upon the received information about the medical procedure; and
generating at least one document containing the list of data sources retrieved from the database, wherein performing the query function comprises
generating a set of queries containing query criteria based on the received information about the medical procedure; and
executing the set of queries to retrieve from the at least one database the list of data sources matching the query criteria, wherein generating the set of queries comprises selecting a set of preexisting queries that correspond to the received information about the medical procedure.

28. The machine-readable medium of claim 27, wherein the information about the medical procedure comprises at least one procedure code indicating the medical procedure performed for the patient.

29. The machine-readable medium of claim 27, wherein the at least one procedure code comprises at least one procedure code according to the Current Procedure Terminology (CPT) or the International Classification of Disease (ICD).

30. The machine-readable medium of claim 29, wherein performing the query function comprises:
generating a set of queries containing query criteria based on the received information about the medical procedure; and
executing the set of queries to retrieve from the at least one database the list of data sources matching the query criteria.
